(19) United States
(12) Patent Application Publication
(10) Pub. No.: US 2007/0118423 A1
(43) Pub. Date: May 24, 2007

(54) Vehicular advertising system

(76) Inventor: Victoria Always, Canyon Lake, CA (US)

Correspondence Address: PHILIP H. HAYMOND, 7545 IRVINE CENTER DRIVE, SUITE 200, IRVINE, CA, 92618-2933, US

(21) Appl. No.: 11/256,244

(22) Filed: Oct. 20, 2005

(51) Int. Cl. G07G 1/14

(52) U.S. Cl. 705/14; 40/591

(57) ABSTRACT

A vehicular advertising system and method for generating an income stream from advertising including a display device mounted on a vehicle. The vehicle owner or lessee will receive an incentive from an advertiser or seller to mount the display device to the vehicle in the form of a payment for a specified period of time. The incentive may be a contribution to the vehicle down payment, periodic vehicle payment or periodic insurance payment made by the advertiser. The display device may be mounted on the rear of a vehicle including an illuminating device wired to the electrical system of the vehicle. The display device may be used in connection with a telephone number or Internet web location to provide a viewer with additional information provided by the advertiser.

### FIELD OF INVENTION

The invention pertains to a system for marketing and displaying advertising messages on vehicles. More particularly, the invention relates to an advertising apparatus, system and method for inducing vehicle owners to use the system.

### BACKGROUND OF THE INVENTION

Various methods and systems have been developed to advertise on automobiles. U.S. Pat. No. 4,928,084 issued to Reiser is directed toward a combined message display and brake light. The system employs a display containing light emitting diodes, that when activated, transmit a message or pattern in red light. A fixed or programmable memory has data stored therein which can be selectively extracted to activate select diodes that convey a single line message. When the brake pedal of the car where the system is mounted is compressed, all of the diodes are activated to produce a solid display of red over the entire screen. As a safety precaution, the diodes remain inactive until the brake pedal is depressed and from then on each subsequent depression of the brake pedal produces a solid display of red over the entire screen.

U.S. Pat. No. 5,825,281 issued to McCreary is directed toward a method of displaying advertising messages. A message to be displayed is sent to the display device from an onboard processor, having been retrieved from memory. The message comes on with the automotive brake lights and remains on until the brakes are released. The message changes with each application of the brake lights and is a continuous loop of sequentially displayed messages. In an alternative embodiment, the display remains on in a dimmer mode until the next application of the brakes changes the message. Thus, the message may be displayed while brake lights are energized, or alternatively, once brake lights are extinguished the message goes to a tail light mode having a reduced illumination level, for example, half as bright.

U.S. Patent Application No. 2004/0267617 filed for Yanase is directed to a method and system for charging a vehicle advertisement rate. In an advertising vehicle, vehicle sensors for detecting the traveling state such as the traveling speed and the traveling position, and an on-vehicle terminal for importing the information detected by the sensors as the traveling state information are mounted. The traveling state information is imported to a vehicle-state collecting server of a prove information center from the on-vehicle terminal through a network. An advertisement rate calculating server calculates the advertisement rate from the traveling state information and data of an advertisement rate system stored beforehand in which unit rates per traveling distance, changing ratio of the unit rates according to the traveled unit area and the like are collected. Then, the information on the advertisement rate and the traveling state information are transmitted to the advertiser terminal.

U.S. Patent Application No. 20020143616 filed for Hajdukiewicz is directed to a System and method for providing a fuel purchase incentive with the sale of a vehicle. A fuel purchase incentive is provided incident to the sale of a vehicle. With respect to the sale of an automobile, the incentive is of a program price, for example a discount price or a capped maximum price, for a specified quantity of a specified brand and type of gasoline. The incentive is calculated as a function of the anticipated geographical and other use factors of the automobile buyer. The incentive information is provided to the buyer at the time of purchase of the automobile and stored for use by an incentive program operator. When the buyer purchases gasoline pursuant to the incentive program, that is of a specified brand, grade and quantity, the purchase information is transmitted to the incentive program operator. A rebate, equal generally to the difference between the retail price and the program price, is calculated and transmitted to a credit card processor for application to a credit card bill. A credit card account identifier is the preferred method of identifying the buyer and providing rebates under the program.

U.S. Patent Application No. 20030055727 filed for Walker et al. is directed to a method and apparatus for facilitating the provision of a benefit to a customer of a retailer. In accordance with one or more embodiments of the present invention, a customer participating in a purchase at a retailer is presented with an offer. The offer defines a benefit and an activity. The benefit is to be provided to the customer if the customer commits to the activity. A benefit may comprise, for example, a refund of a purchase total of the purchase during which the offer was output to the customer. The customer, at a time after the purchase during which the offer is output and after considering the offer, may accept the offer at a POS device or rebate device of the retailer. The benefit may be provided to the customer at the time of acceptance. The customer may be committed to the activity at the time of acceptance.

Vehicles have become progressively more expensive to purchase, insure and otherwise maintain. Most vehicle purchasers must resort to obtaining a loan for purchase of a vehicle and the payments for the loan and upkeep and insurance and other costs have put vehicle ownership either out of reach for many, or caused owners to purchase a lower quality vehicle than desired. Advertisers are generally interested in sending their message to as wide an audience as possible, in order to increase the sales of goods and services that they advertise.

What is needed is a method and apparatus to allow vehicle owners to defray the costs of their vehicle by allowing their vehicles to be used in advertising. It is therefore an objective of the present invention to provide an apparatus additionally a method for displaying advertising on vehicles. It is a further objective to provide a system and method for encouraging vehicle owners or operators to attach the apparatus to their vehicles and to use it to display desired advertising and also to generate a revenue stream by such advertising. It is still a further objective to encourage these owners or operators to continue to use the advertising display system over an extended period of time. Finally, it is another objective of the present invention to synchronize the display advertising system with a vehicle's brake-light system.

The foregoing objectives should not be viewed as limiting, further objects and advantages of the invention will become apparent to one skilled in the art by reading and understanding the following detailed description and the drawings to which it refers.

### SUMMARY OF THE INVENTION

A vehicular advertising system having the desired features may be constructed from the following components. A display fixture is provided, which may be an illuminated display fixture. The fixture is attached to a vehicle and connected to the electrical system of the vehicle. An incentive is provided for individuals who wish to possess or who possess a vehicle, such as a vehicle buyer, owner, lessee or renter, collectively referred to as a vehicle owner, to attach the display fixture to the vehicle and display advertising on the fixture for a predetermined period of time.

In a variant of the invention, the incentive is periodic payments from an advertiser to a vehicle buyer or a vehicle lessee. The payments are conditioned upon attachment of the display fixture to the vehicle and continued display of designated advertising using the display fixture. When a vehicle buyer or a vehicle lessee attaches the display fixture to the vehicle and continues to display the designated advertising, the advertiser will continue to make the periodic payments.

In another variant, the incentive is a contribution to a down payment for a vehicle purchase or vehicle lease.

In still another variant, the incentive is a contribution to a periodic payment for a vehicle purchase or a vehicle lease.

In yet another variant, the incentive is a contribution to a periodic payment for vehicle insurance.

In a further variant, the vehicular advertising system further includes a translucent panel attached adjacent a source of illumination.

In still a further variant, the display fixture accommodates interchangeable translucent panels.

In another variant of the invention, the illuminating source is connected to a brake lighting system of the vehicle. When a vehicle brake is applied, the display fixture will be illuminated.

In still another variant, the fixture further includes a panel of light emitting diodes (LEDs) arranged in a grid. A programmable controller is connected to the grid and the controller is programmed by methods known to those of skill in the art to provide a display messages or images. The controller may be connected to an electrical system of the vehicle as an electrical current power source. When a program is provided to the controller, a stationary, a moving or a scrolling advertising display is produced.

In yet another variant, the panel of LEDs is capable of providing textual messages. In a further variant, the panel of LEDs is capable of providing graphical images.

In a further variant of the invention, the panel of LEDs is connected to a brake lighting system of the vehicle. When a vehicle brake is applied, the panel will be activated and the advertising display will be visible.

Various methods for generating a revenue stream from advertising in connection with the transfer of ownership of a vehicle are included in the invention. In general each of the methods includes the steps of making an agreement between an advertiser and a vehicle owner to affix a display fixture to a vehicle by providing an incentive to the owner of the vehicle in the form of contribution by the advertiser to the cost of the vehicle, then affixing the display device to the vehicle so that the display device is positioned to be viewed by a viewer outside the vehicle when the vehicle is operated.

The agreement can be achieved through intermediaries such as having the advertiser form an agreement with a vehicle seller to offer the incentive to the buyer/owner, or even a broker that facilitates offers by advertisers to pay sellers to offer incentives to buyers. In this manner, the seller, owner and broker can each receive revenue from the transaction.

The incentive can be any of the cost of owning the vehicle, such as but not limited to a contribution to the periodic payments by the advertiser to the vehicle owner conditioned upon attachment of the display fixture to the vehicle, a contribution by the advertiser to a down payment for the vehicle, a contribution by the advertiser to a periodic payment to pay a loan made for the vehicle, or a contribution to a periodic payment for insurance on the vehicle.

In the preferred embodiment the display fixture is an unobtrusive badge. The display device may include indicator information to indicate to a viewer how further information concerning the object of the advertising may be obtained. For example the indicator information may be but is not limited to an Internet web location or telephone number. The viewer may be given a second incentive for using the indicator information, such as a coupon for making the inquiry.

The indicator information may also indicate and identify the specific vehicle, for example to keep track of the advertising effectiveness of the display fixture when a user inquires about the advertised product or service at the Internet web location or by calling the telephone number.

The display device may further include a ground positioning system (GPS) or the viewer himself may have a telephone or equivalent device in his possession with a ground positioning system, so that the viewer can call the telephone number to obtain directions from the location of the viewer to a location designated by the advertiser, from the coordinates reported by either ground positioning system.

In this respect, before explaining at least one embodiment of the invention in detail it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of an embodiment of the invention, illustrating a display fixture attached to the rear of a vehicle and illuminated by the vehicle's electrical system;

FIG. 2 is a front elevation view of the disassembled display fixture of FIG. 1 illustrating interchangeable translucent panels with display advertising;

FIG. 3 is a perspective view of the invention illustrating a display fixture wired to the vehicle's brake lighting system;

FIG. 4 is a schematic view illustrating an embodiment of the invention incorporating an LED panel, programmable controller and power supply;

FIG. 5 is a front elevation view of the display of the FIG. 4 embodiment illustrating a graphical message; and

FIG. 6 is a front elevation view of the display of the FIG. 4 embodiment illustrating a textual message.

FIG. 7 is a flowchart of methods of the present invention.

FIG. 8 is the preferred embodiment of the invention, an unobtrusive logo is displayed on a badge to be used with a method of the present invention.

### DETAILED DESCRIPTION OF THE INVENTION

As illustrated in the following figures, the apparatus of a vehicular advertising system 10 having the desired features may be constructed from the following components. In this embodiment an illuminated display fixture 14 is provided. The fixture 14 is attached at 18 to a vehicle 22 and electrically connected to the electrical system 30 of the vehicle 22. An incentive is provided for a vehicle owner to attach the display fixture 14 to the vehicle 22 and display advertising 42 on the fixture 14 for a predetermined period of time, which may be for any convenient length, even as long as the entire life of the vehicle.

In a variant of the invention, the incentive is periodic payments from an advertiser to a vehicle owner. The payments are conditioned upon attachment of the display fixture 14 to the vehicle 22 and continued display of designated advertising 42 using the display fixture 14. When a vehicle buyer or a vehicle lessee attaches the display fixture 14 to the vehicle 22 and continues to display the designated advertising 42, the advertiser will continue to make the periodic payments.

In another variant, the incentive is a contribution to a down payment for a vehicle purchase or vehicle lease.

In still another variant, the incentive is a contribution to a periodic payment for a vehicle purchase or a vehicle lease.

In yet another variant, the incentive is a contribution to a periodic payment for vehicle insurance (not shown).

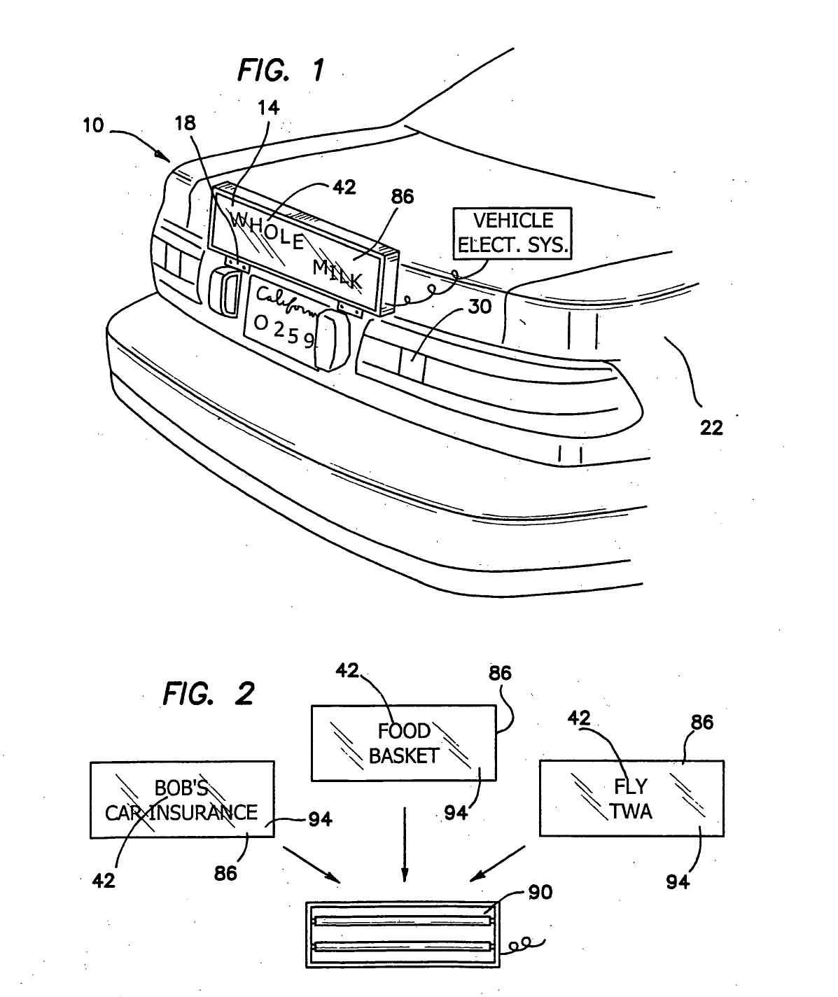

In a further variant, as illustrated in FIGS. 1-3, the vehicular advertising system 10 further includes a translucent panel 86 attached adjacent an illumination or illuminating source 90, such as a light bulb.

In still a further variant, as illustrated in FIG. 2 the display fixture 14 accommodates interchangeable translucent panels 94.

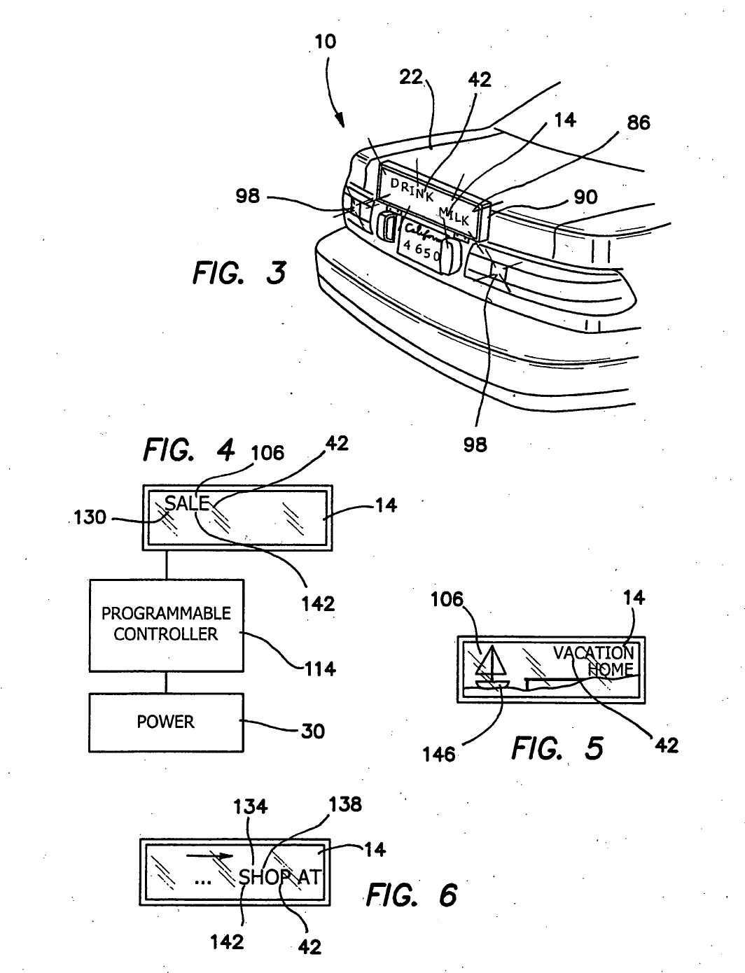

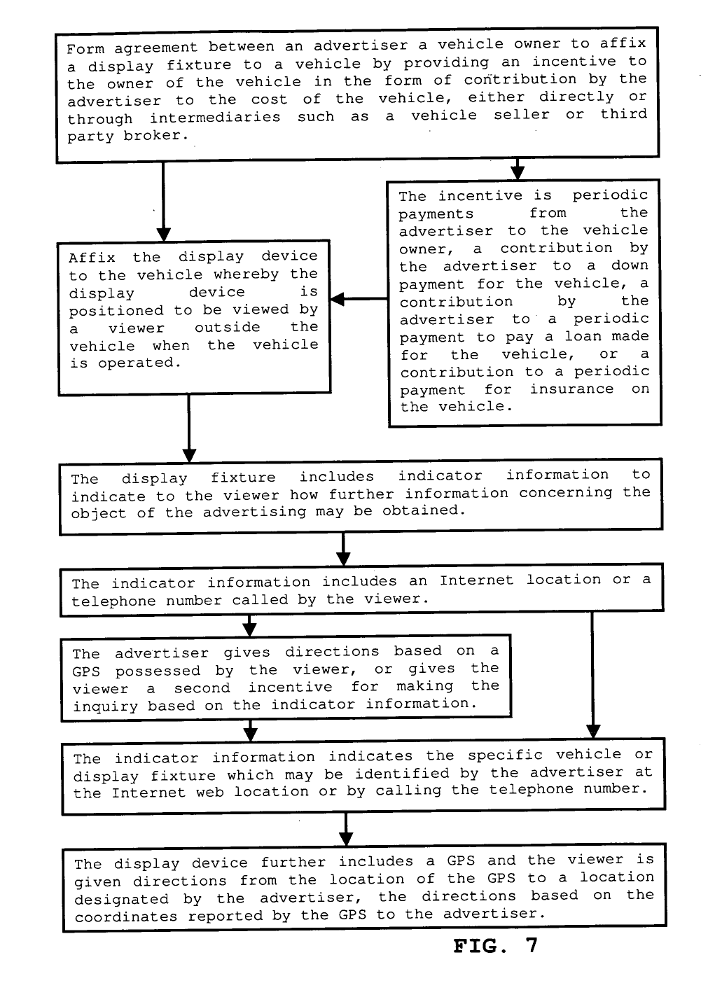

In another variant of the invention, as illustrated in FIG. 3, the illuminating source 90 is connected to a brake lighting system 98 of the vehicle 22. When the brake of the vehicle (not shown) is applied, the display fixture 14 will be illuminated.

In still another variant, as illustrated in FIGS. 4-6, the fixture 14 further includes a panel of light emitting diodes (LEDs) 106 arranged in a grid (not shown). A programmable controller 114 is connected to the grid. The programmable controller 114 is programmed by methods known to those of skill in the art to provide a display messages or images, providing a display program to the controller 114. The programmable controller 114 is connected o an electrical system 30 of the vehicle 22 as a power source. When a program is provided to the controller 114, a stationary 130, a moving 134 or a scrolling 138 advertising display 42 is produced.

In yet another variant, as illustrated in FIGS. 4 and 6, the panel of LEDs 106 is capable of providing textual messages 142.

In a further variant, as illustrated in FIG. 5, the panel of LEDs 106 is capable of providing graphical images 146.

In another variant of the invention, as illustrated in FIG. 3, the panel of LEDs 106 is connected to a brake lighting system 98 of the vehicle 22. When a vehicle brake is applied, the panel 106 will be activated and the advertising display 42 will be visible.

Generally the method of the present to implement advertising and provide an income stream from the implementation is to form an agreement between an advertiser and a vehicle seller to provide an incentive for a customer who is or wishes to become a vehicle owner to affix a display fixture to a vehicle. Again the definition of vehicle owner as used, unless otherwise stated, is meant to include but not be limited to vehicle purchasers, lessees and renters, as well as those already actually owning, leasing or renting a vehicle. The agreement then may be made at the point of sale (or rental or leasing) of the vehicle or afterwards. The agreement made be made directly between an individual wishing to advertise and a vehicle seller, or through a broker administering a collection of such agreements.

The incentive is provided for individuals who wish to possess or who possess a vehicle, such as a vehicle buyer, owner, lessee or renter, collectively referred to as a vehicle owner, to attach the display fixture to the vehicle and display advertising on the fixture for a predetermined period of time. The incentive may be periodic payments from an advertiser to a vehicle owner conditioned upon attachment of the display fixture to the vehicle and continued display of designated advertising using the display fixture; the incentive may be a contribution to a down payment for a vehicle purchase or vehicle lease; the incentive may comprise a contribution to a periodic payment for a vehicle purchase or a vehicle lease; the incentive may be a contribution to a periodic payment for vehicle insurance.

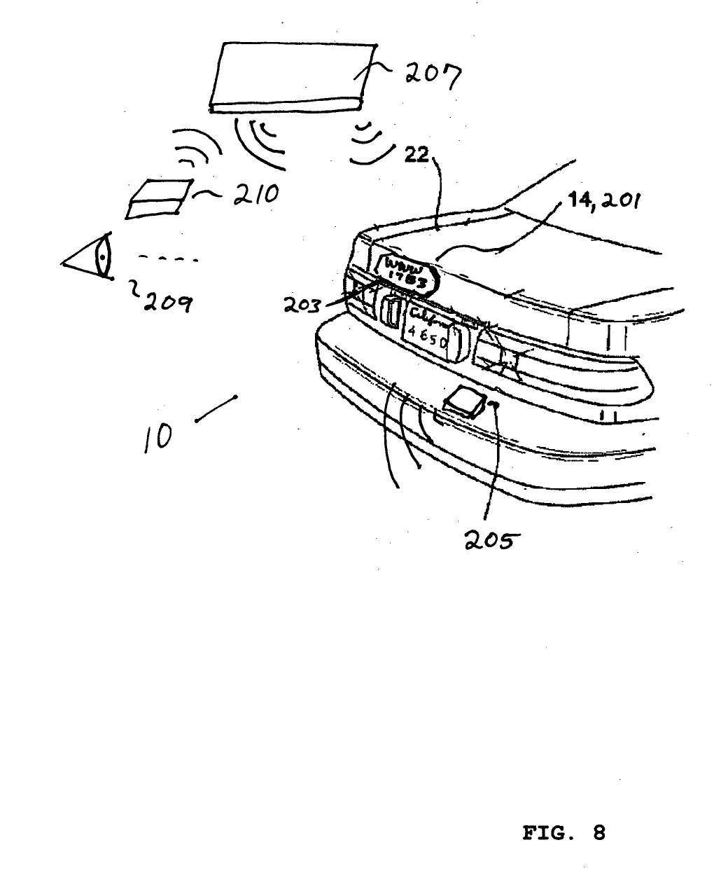

Referring additionally to FIG. 8, the preferred embodiment of the vehicular advertising system 10 of the invention is shown. In this embodiment the display fixture 14 is a badge or button 201 displaying, for example, the logo of a company or other object of promotion of advertising. The badge 201 is affixed to the vehicle 22 with or without illumination. A more unobtrusive badge is preferred because it is believed that the pronounced or garish the advertising on the vehicle is, the more likely a vehicle owner will be to partake of the method of the invention.

The display fixture 14 badge 201 to be used with a method of the present invention in this embodiment may further include indicator information 203, such as an alphanumeric string or Internet web location, to indicate how further information concerning the object of the advertising may be obtained. When another driver views the badge (dotted line), the other driver may use a telephone or cell phone to obtain further information on the product or service offered, or perhaps the directions to the nearest location of a store. Alternatively a Global Positioning System, a GPS 205 could be provided on the vehicle 22 to be used in conjunction with information in the indicator information 203 to identify which vehicle is being referenced by the cell phone user, and give directions to a viewer 209 from the current location of the vehicle 22. The advertiser might also give a promotional incentive such as a coupon to the viewer when he calls. A typical GPS receiver is known to those of skill in the art, using a triangulation mechanism to calculate its position. The GPS receiver then forwards its location to a computer 207 via a wireless data network. A viewer 209 could obtain directions to a store from calling the computer 207 via his own cellular phone (broadcast shown as curved lines), for example using his phone as an Internet browser. The computer 207 could also keep track of inquires for particular indicator information 203 to measure the effectiveness of the using that display fixture.

Many cell phones are currently available with a GPS 210, that can be used in conjunction with the advertising method of the present invention. For example, a viewer 209 could enter the indicator information 203 and be given directions to the nearest venue where the goods or services are available, using the current location of the user.

It will be appreciated that the invention has been described hereabove with reference to certain examples or preferred embodiments as shown in the drawings. Various additions, deletions, changes and alterations may be made to the above-described embodiments and examples without departing from the intended spirit and scope of this invention. Accordingly, it is intended that all such additions, deletions, changes and alterations be included within the scope of the following claims.

Note the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A vehicular advertising system comprising:
a display fixture affixed to a vehicle and an incentive for a vehicle owner to attach said display fixture to said vehicle and display advertising on said fixture for a predetermined period of time.

2. The vehicular advertising system of claim 1 further comprising:
an illuminated display fixture, said fixture attached to a vehicle having an electrical system and connected to the electrical system of said vehicle; and
an incentive for a vehicle owner to attach said display fixture to said vehicle and display advertising on said fixture for a predetermined period of time.

3. The vehicular advertising system, as described in claim 2, wherein said incentive comprises:
periodic payments from an advertiser to either of a vehicle buyer and a vehicle lessee;
said payments being conditioned upon attachment of said display fixture to said vehicle and continued display of designated advertising using said display fixture; and
whereby, when said either of a vehicle buyer and a vehicle lessee attach said display fixture to said vehicle and continue to display said designated advertising, said advertiser will continue to make said periodic payments.

4. The vehicular advertising system, as described in claim 1, wherein said incentive comprises a contribution to a down payment for either of a vehicle purchase, a contribution to a periodic payment for either of a vehicle purchase, or a contribution to a periodic payment for vehicle insurance.

5. The vehicular advertising system, as described in claim 2, further comprising translucent panel attached adjacent an illuminating source.

6. The vehicular advertising system, as described in claim 7, wherein said display fixture accommodates interchangeable translucent panels.

7. The vehicular advertising system, as described in claim 2, wherein:
said illuminating source is connected to a brake lighting system of said vehicle; and
whereby when a vehicle brake is applied, said display fixture will be illuminated.

8. The vehicular advertising system, as described in claim 2, wherein said fixture further comprises:
a panel of light emitting diodes (LEDs) arranged in a grid;
a programmable controller connected to said grid and to the electrical system of said vehicle,
the programmable controller being programmed with a display program;
whereby, when a program is provided to said controller, either of a stationary, a moving and a scrolling advertising display is produced.

9. The vehicular advertising system, as described in claim 8 wherein said panel of LEDs is capable of providing textual messages.

10. The vehicular advertising system, as described in claim 8 wherein said panel of LEDs is capable of providing graphical images.

11. The vehicular advertising system, as described in claim 8, wherein:
said panel of LEDs is connected to a brake lighting system of said vehicle; and
whereby when a vehicle brake is applied, said panel will be activated and said advertising display will be visible.

12. A method for generating a revenue stream from advertising in connection with the transfer of ownership of a vehicle, comprising the steps of:
making an agreement between an advertiser a vehicle owner to affix a display fixture to a vehicle by providing an incentive to the owner of the vehicle in the form of contribution by the advertiser to the cost of the vehicle,
affixing the display device to the vehicle whereby the display device is positioned to be viewed by a viewer outside the vehicle when the vehicle is operated.

13. The method of claim 12 where the incentive is offered to the owner by a vehicle seller by forming an agreement to do so between the seller and the advertiser.

14. The method of claim 12 where the agreement between the advertiser and seller is achieved through a broker or including the steps of a broker forming agreements with an advertiser and a seller.

15. The method of claim 12 where the incentive is periodic payments from an advertiser to the vehicle owner conditioned upon attachment of the display fixture to the vehicle, a contribution by the advertiser to a down payment for the vehicle, a contribution by the advertiser to a periodic payment to pay a loan made for the vehicle, or a contribution to a periodic payment for insurance on the vehicle.

16. The method of claim 12 where the display fixture is a badge.

17. The method of claim 12 where the display fixture further includes indicator information to indicate to the viewer how further information concerning the object of the advertising may be obtained.

18. The method of claim 17 where the display device further includes an Internet web location or telephone number.

19. The method of claim 18 where the indicator information indicates the specific vehicle or display fixture which may be identified by the advertiser at the Internet web location or by calling the telephone number.

20. The method of claim 19 where the display device further includes a ground positioning system or the viewer has a telephone or equivalent device with a ground positioning system, and the viewer can obtain directions from the location of the viewer to a location designated by the advertiser from the coordinates reported by the ground positioning system.

21. The method of claim 18 where the viewer is given a second incentive for using the indicator information.

22. The method of claim 19 where the effectiveness of the specific display fixture is calculated by the advertiser based on the number of inquiries based on the indicator information.

23. The method of claim 12 where the display fixture is illuminated by an illuminating source connected to the electrical system of the vehicle said vehicle.

24. The method of claim 23 where the display device further comprises a translucent panel attached adjacent the illuminating source.

25. The method of claim 24, where the display fixture accommodates interchangeable translucent panels.

26. The method of claim 23 wherein the illuminating source is connected to a brake lighting system of said vehicle, whereby when a vehicle brake is applied the display fixture will be illuminated.

27. The method of claim 12 where the display fixture further comprises a panel of light emitting diodes (LEDs) arranged in a grid;
a programmable controller connected to said grid and to the electrical system of said vehicle,
the programmable controller is programmed with a display program;
whereby, when a program is provided to said controller, either of a stationary, an advertising display is produced.

28. The method of claim 27 where the advertising display is a textual message.

29. The method of claim 27 where the advertising display is a graphical image.

30. The method of claim 27 where the panel of LEDs is connected to a brake lighting system of said vehicle; whereby when a vehicle brake is applied, the panel will be activated and said advertising display will be visible.
